(19) United States
(12) Patent Application Publication
(10) Pub. No.: US 2021/0387319 A1
(43) Pub. Date: Dec. 16, 2021

(54) OPERATION MODE SWITCHING DEVICE AND OPERATION MODE SWITCHING DEVICE OF ELECTRIC TOOL

(71) Applicant: TECHWAY INDUSTRIAL CO., LTD., Taichung City (TW)

(72) Inventors: Fu-Hsiang CHUNG, Taichung City (TW); Fu Sheng HSUEH, Taichung City (TW); Chien Yu LEE, Taichung City (TW); Ying Chih WANG, Taichung City (TW)

(21) Appl. No.: 17/331,887

(22) Filed: May 27, 2021

(30) Foreign Application Priority Data
Jun. 10, 2020 (TW) 109119401

(51) Int. Cl. B25F 5/00

(52) U.S. Cl. CPC B25F 5/001

(57) ABSTRACT

The invention relates to an operation mode switching device comprising: a rotatable driving unit; a manipulation signal and an operation for switching operation mode generated by a change in the manipulation signal; and a processing portion electrically connected to the driving unit and receiving the manipulation signal and the operation for switching operation mode, the processing portion is capable of receiving the manipulation signal to drive the driving unit, the processing portion receives the operation for switching operation mode within a time interval, the processing portion determines that it is an operation mode switching request, and the processing portion is capable of modulating an operation mode of the driving unit by performing the operation for switching operation mode through the manipulation signal of controlling an electric tool originally, and an operation mode switching function can be added without adding components and modifying an original design.

### BACKGROUND OF THE INVENTION

### Field of Invention

The invention relates to electric tools, and more particularly to an operation mode switching device that is easy to operate and does not need to change an original structure of electric tools.

### Related Art

FIG. 1 shows a conventional electric tool 10, which has a driving unit 11, a trigger 12, an operation mode switching unit 13 and a reversing member 14, the user can use the operation mode switching unit 13 to switch the operation mode and the reversing member 14 to switch rotation direction of the driving unit 11, for switching operation mode of the electric tool 10, different operation modes are available for switching options, such as constant torque operation/maximum torque output operation, high/low torque operation, and high/low rotation speed, and through continuously pressing the trigger 12, the driving unit 11 can be driven to operate in the selected operation mode.

However, in the above-mentioned prior art, the common electric tool 10 is basically provided with only the trigger 12 and the reversing unit 14, and thus the electric tool 10 has only basic control of driving rotation and rotation direction. If the electric tool 10 needs additional operation mode, relevant components of the operation mode switching unit 13 must be added. Therefore, in addition to increasing the use of components and circuit boards, and increasing the manufacturing cost; the original components used in the electric tool 10 will also need to be redesigned, such as redeveloping molds and circuits or changing component positions, etc., which increase the functions and increase a great deal of costs comparatively. Moreover, adding an operating element will relatively increase the number of buttons used and increase the complexity of the interface.

### SUMMARY OF THE INVENTION

An object of the invention is to provide an operation mode switching device capable of switching operation modes of a driving unit without adding new components.

In order to achieve the above object, the invention provides an operation mode switching device comprising:

a rotatable driving unit;

a manipulation signal; and

a processing portion electrically connected to the driving unit, the processing portion is capable of receiving the manipulation signal to drive the driving unit, if an operation for switching operation mode formed by a change in the manipulation signal is received within a time interval, the processing portion determines that is an operation mode switching request, and the processing portion switches an operation mode of the driving unit;

preferably, the operation mode comprises at least one constant torque (pre-lock) mode and one maximum torque output mode;

preferably, the operation mode comprises at least one high torque mode and one low torque mode;

preferably, the operation mode comprises at least one high rotation speed mode and one low rotation speed mode; and

an operation mode switching device of an electric tool comprising:

a main body mounted with a rotatable motor;

a manipulation unit capable of triggering to generate a manipulation signal;

the manipulation unit is capable of triggering regularly to form an operation for switching operation mode; and

a control unit having a microprocessor and a switch element, the control unit is electrically connected to the motor of the main body and the manipulation unit, the control unit is capable of receiving the manipulation signal of the manipulation unit, the microprocessor controls the switch element according to the manipulation signal so that the switch element is capable of driving the motor to operate and changing a direction of operation; after the microprocessor receives the operation for switching operation mode of the manipulation unit within a time interval, the microprocessor determines that the operation for switching operation mode is an operation mode switching request, the microprocessor is capable of changing an operation mode, and controlling the switch element to change the operation mode of the motor.

Preferably, the operation mode is to control the switch element to change an operating torque of the motor.

Preferably, the operation mode is to control the switch element to change an operating rotation speed range of the motor.

The operation mode switching device provided by the invention generates the operation for switching operation mode by changing the manipulation signal within the time interval through the existing manipulation unit, so that the processing portion determines that the operation for switching operation mode is an operation mode switching request, and switches the operation mode of the driving unit to make existing electric tools to be capable of generating a function of switching operation mode without requiring to add new components and circuit boards and without requiring to modify the existing device structure, and capable of achieving a function of switching the operation mode of the driving unit without increasing costs, components and circuit boards.

### BRIEF DESCRIPTION OF THE DRAWINGS

In order to enable the examiner to further understand the objects, features, and achieved efficacies of the invention, two preferred embodiments are described below for detailed explanation in conjunction with the drawings.

FIG. 1 is a perspective view of a conventional electric tool;

FIG. 2 is a perspective view of an electric tool according to a preferred embodiment of the invention;

FIG. 3(A) is a structural block diagram of the electric tool;

FIG. 3(B) is a block diagram of signal composition of the electric tool;

FIG. 4 is a diagram of manipulation signals of a reversing member of a manipulation unit and an action signal of a driving unit of the electric tool;

FIG. 5 is a diagram of the manipulation signal of a trigger of the manipulation unit and the action signal of the driving unit of the electric tool;

FIG. 6(A) is a signal diagram of the manipulation signals of the reversing member of the manipulation unit and an operation mode of the driving unit switching from a constant torque (pre-lock) to a maximum torque output;

FIG. 6(B) is a signal diagram of the manipulation signals of the reversing member of the manipulation unit and an operation mode of the driving unit switching from a maximum torque output to a constant torque (pre-lock);

FIG. 7(A) is a signal diagram of the manipulation signal of the trigger of the manipulation unit and an operation mode of the driving unit switching from a constant torque (pre-lock) to a maximum torque output;

FIG. 7(B) is a schematic diagram of an operation mode switching signal of the trigger of the manipulation unit exceeding a time interval;

FIG. 8 is a signal diagram of the manipulation unit switching from a constant torque to a maximum torque output by the manipulation signals of the trigger and the reversing member and a rotation speed of the driving unit;

FIG. 9 is a structural block diagram of the electric tool according to a second preferred embodiment of the invention;

FIG. 10(A) is a signal diagram of a first high/low speed torque switching operation of a two-way trigger of the manipulation unit; and

FIG. 10(B) is a signal diagram of a second high/low speed torque switching operation of the two-way trigger of the manipulation unit.

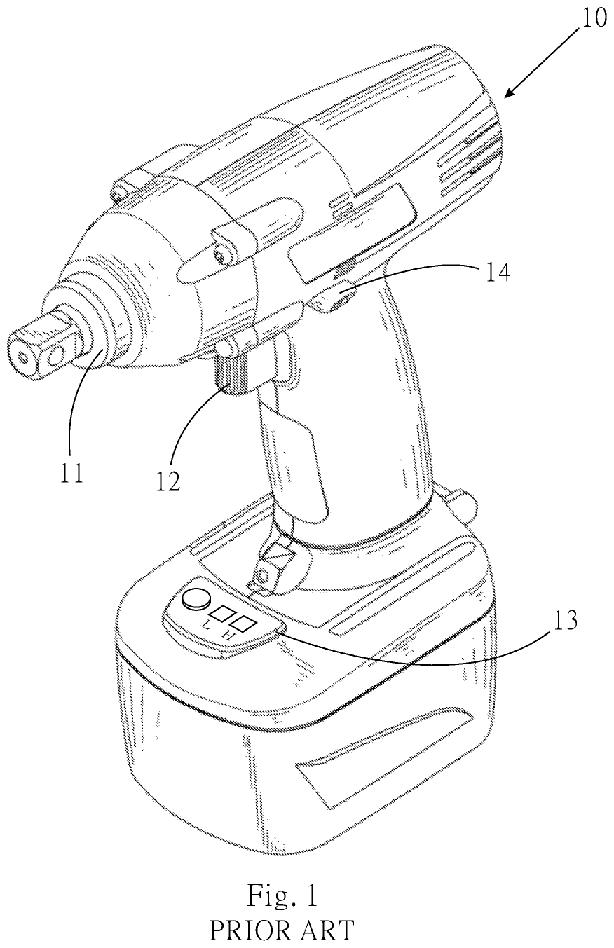

### DETAILED DESCRIPTION OF THE INVENTION

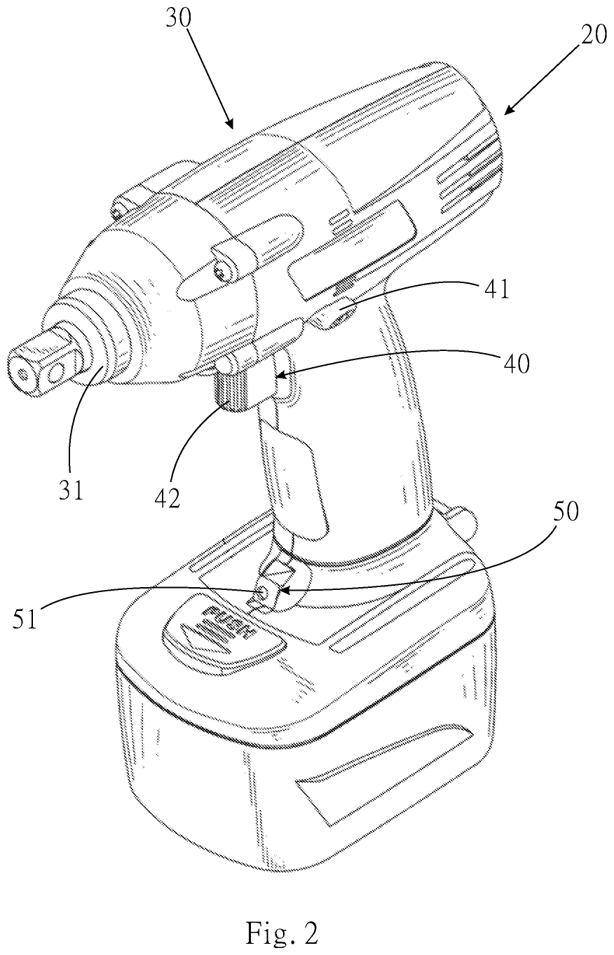

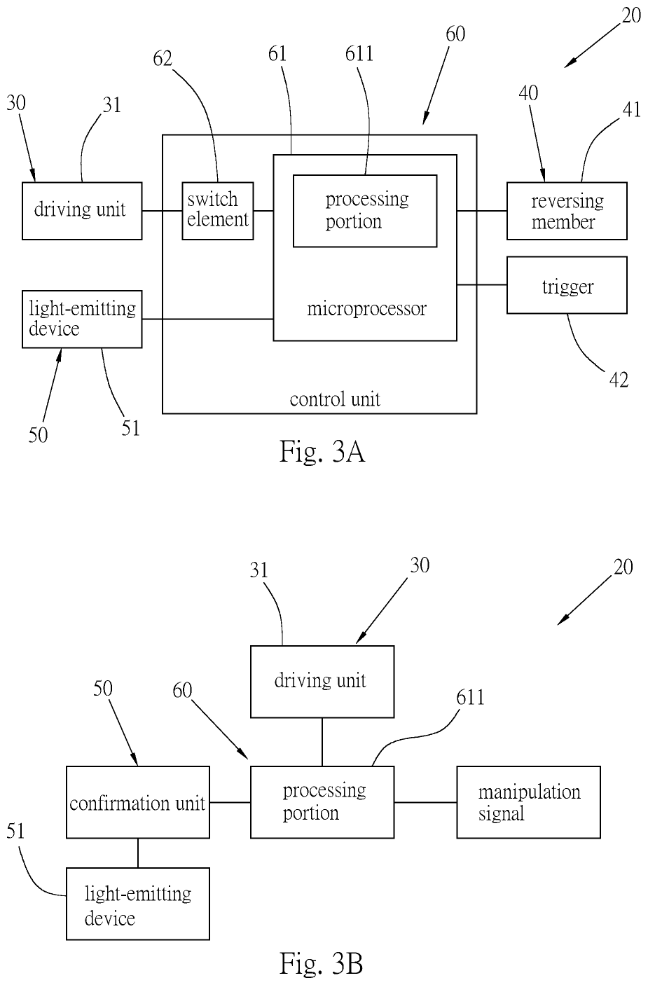

Please refer to FIGS. 2, 3(A) and 3(B). An electric tool 20 provided by a preferred embodiment of the invention comprises a main body 30, a manipulation unit 40, a confirmation unit 50 and a control unit 60.

The main body 30 is mounted with a rotatable driving unit 31, which can be composed of a DC brush motor or a DC brushless motor, and through rotation of the driving unit 31, the main body 30 is capable of generating application of force in a direction of rotation.

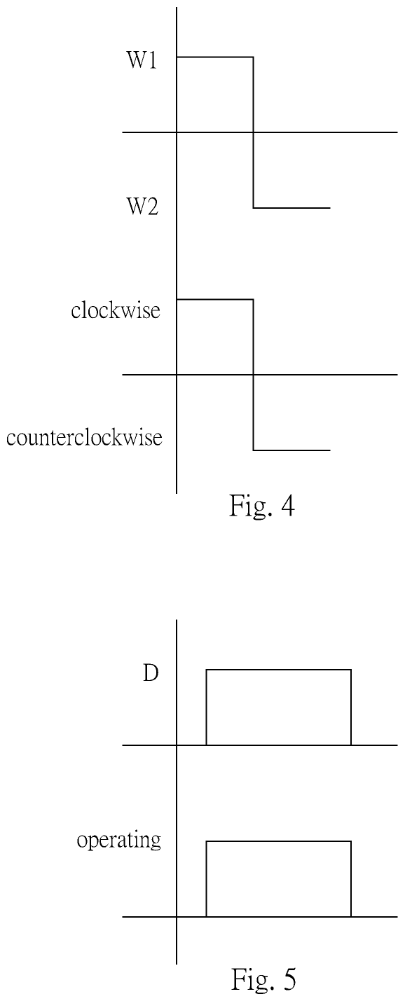

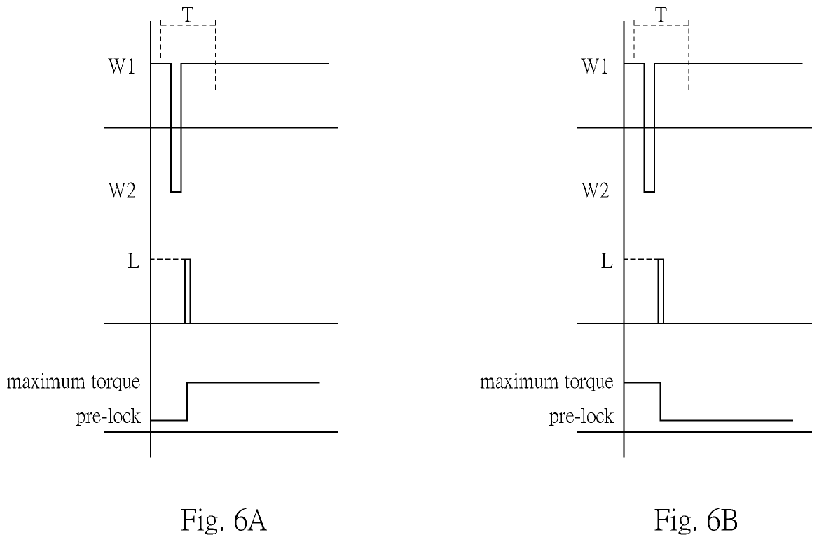

The manipulation unit 40 comprises a reversing member 41 and a trigger 42. The manipulation unit 40 is installed on the main body 30. The manipulation unit 40 is capable of generating a manipulation signal and forming an operation for switching operation mode by regularly triggering the manipulation signal; an operation mode of the electric tool 20 can be selected from constant torque (pre-lock)/maximum torque, high/low torque and high/low rotation speed or other operation mode, which is not limited thereto. Please refer to FIG. 4, the reversing member 41 in this embodiment is a button capable of being pushed to move back and forth on left and right sides of the main body 30, but it is not limited thereto, for example, can be a rotatable knob or button. The reversing member 41 has triggerings of two different rotation direction positions to control a rotation direction of the driving unit 31 of the main body 30, the manipulation signal generated by the reversing member 41 is a clockwise or a counterclockwise manipulation signal W1, W2; a single direction manipulation signal can also be generated, direction switching action can be generated through triggering the single direction manipulation signal, and the direction manipulation signal triggered and generated each time can perform one direction switching action. In this embodiment, the reversing member 41 is switched to a clockwise position to generate triggering of the clockwise manipulation signal W1, and when being switched to a counterclockwise position, triggering of the counterclockwise manipulation signal W2 is generated. Please refer to FIGS. 6(A) and 6(B). When the reversing member 41 within a time interval T, such as 1 second or 2 seconds, which is not limited thereto, is switched from the clockwise position to the counterclockwise position and then switched back to the clockwise position, triggering of a direction manipulation signal of W1-W2-W1 is generated, that is, an action of the reversing member 41 being switched back and forth twice, and a different direction manipulation signal can also be triggered by switching the reversing member 41 back and forth four times. At this time, the reversing member 41 triggers the manipulation signal regularly to form the operation for switching operation mode. Similarly, when the reversing member 41 is switched from the original counterclockwise position to the clockwise position and then switched back to the counterclockwise position, triggering of a direction manipulation signal of W2-W1-W2 is also generated, and regular manipulation signal changes are generated by the reversing member 41 through triggering to form the operation for switching operation mode. Manipulation signal changes generated by the manipulation signal and the operation for switching operation mode are transmitted to the control unit 60.

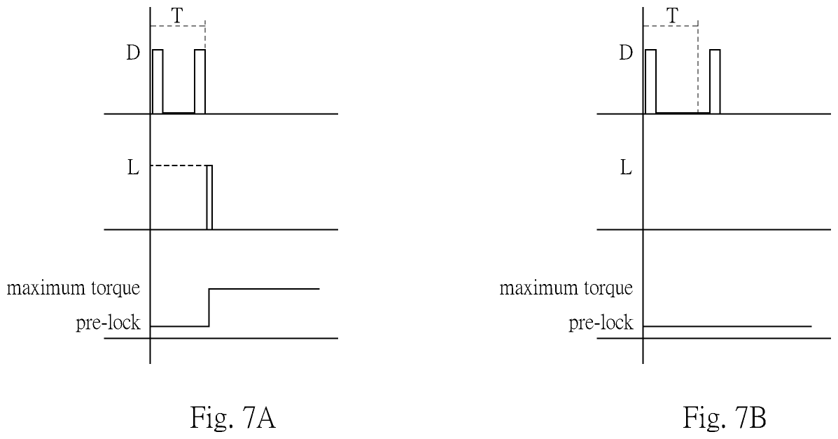

Please refer to FIGS. 5 and 7(A). Similarly, when the trigger 42 is continuously pressed, the triggered manipulation signal is a driving manipulation signal D capable of driving the driving unit 31 of the electric tool 30 to rotate. When the trigger 42 is pressed and then released immediately, a pressing action is formed, that is, a trigger of a manipulation signal is formed. In this embodiment, it is set to repeatedly press the trigger 42 twice. Within the time interval T, the trigger 42 will form an operation for switching operation mode, the manipulation signal and the operation for switching operation mode generated by regularly triggering the manipulation signal are transmitted to the control unit 60.

The manipulation unit 40, that is, the reversing member 41 and the trigger 42, are the basic structures originally provided on the electric tool 30, when being used, there is no need to add additional components or change the design, operation for switching operation mode can be performed for the electric tool 20.

The confirmation unit 50 in this embodiment is a light-emitting device 51, such as an LED (lighting) light commonly used in electric tools, which can be used for lighting during operation. The light-emitting device 51 is also capable of generating a signal change of lightness and dimness. When the trigger 42 is pressed to wake up the control unit 60, the confirmation unit 50 will produce a light up display, and after the trigger 42 is pressed and released, the confirmation unit 50 will continue to emit light for about 3-5 seconds. The control unit 60 is capable of receiving command. In addition, the confirmation unit 50 can also use the driving unit 31 to display confirmation action. The confirmation unit 50 does not need to add other components, and can be implemented with a conventional structure.

The control unit 60 comprises a microprocessor 61 and a switch element 62. The microprocessor 61 has a processing portion 611 built therein; the microprocessor 61 is electrically connected to the reversing member 41 and the trigger 42 of the manipulation unit 40, and connected to the motor of the driving unit 31 through the switch element 62. The processing portion 611 is capable of receiving different manipulation signals in the manipulation unit 40 to control the switch element 62 to rotate the driving unit 31 or switch a direction of rotation of the driving unit 31, and after the trigger 42 of the manipulation unit 40 is pressed, within the time interval T after the control unit 60 is awakened, if the operation for switching operation mode generated by the manipulation unit 40 regularly triggering the manipulation signal is received, the processing portion 611 determines that there is an operation mode switching request, the processing portion 611 is capable of controlling the switch element 62 by an internally written program to generate a switching time or changes in number of times. The switch element 62 can be an insulated gate bipolar transistor (IGBT) or a metal oxide semiconductor field effect transistor (MOSFET) in order to energize a coil according to a correct sequence, thereby a change in operation mode can be formed for the driving unit 31 through PWM (pulse width modulation), such as a constant torque/maximum torque output drive, two torque changes of one high torque and one low torque, or changes of rotation speed range of one high rotation speed and one low rotation speed; it can also be two different values of constant torque (pre-lock)/maximum torque output mode change, changes of three torque values of a high torque, a medium torque and a low torque, or changes of rotation speed range of one high rotation speed, one middle rotation speed and one low rotation speed. After the control unit 60 has received the operation for switching operation mode of the manipulation unit 40 within the time interval T, the processing portion 611 determines that the operation for switching operation mode is an operation mode switching request, the processing portion 611 of the microprocessor 61 switches to different operation modes to control the switch element 62, and at the same time, the processing portion 611 outputs a confirmation signal L to the confirmation unit 50 to show a display of switching operation mode, for example, a light of the light-emitting device 51 blinks or changes from lightness to dimness. Please refer to FIG. 7(B). If the time interval T is exceeded when the manipulation unit 40 performs the operation for switching operation mode, the processing portion 611 determines that a change in the manipulation signal is not an operation mode switching request, that is, the operation mode switching action can not be performed, and the processing portion 611 will not generate the confirmation signal L.

Please refer to FIGS. 2 to 5. When the electric tool 20 is in operation, the manipulation unit 40 can be used to drive the driving unit 31. For example, a position of the reversing member 41 can be switched so that the reversing member 41 being in a clockwise position is capable of generating the clockwise manipulation signal W1. When the processing portion 611 of the microprocessor 61 receives the signal W1, the processing portion 611 will drive the driving unit 31 to rotate in a clockwise direction when rotating. Vice versa, the reversing member 41 being in a counterclockwise position is capable of generating the counterclockwise manipulation signal W2. When the processing portion 611 of the microprocessor 61 receives the signal W2, the processing portion 611 will control the switch element 62 to drive the driving unit 31 to rotate in a counterclockwise direction when rotating. When the trigger 42 is continuously pressed, the driving manipulation signal D can be generated. After the driving manipulation signal D is transmitted to the processing portion 611 of the microprocessor 61, the processing portion 611 of the microprocessor 61 controls the switch element 62 to drive the driving unit 31 to operate in a currently set operation mode, for example, operating in a set torque (pre-lock) mode. When being set to operate with a torque, the processing portion 611 of the microprocessor 61 controls the switch element 62 to operate for a predetermined time or a predetermined number of times, so that a force applied by the electric tool 20 when being driven is capable of reaching a set torque value.

When operating in a set torque (pre-lock) mode, the microprocessor 61 is capable of detecting changes in an electric current value of the driving unit 31, and through changes in the electric current value, it can be known whether the driving unit 31 has been in contact with a workpiece, and whether the driving unit 31 has started to process the workpiece (not shown in the figures). If it is determined that processing has been started (for example, an operating current value has exceeded a predetermined value), a processing time or a number of times of increase and decrease of electric current (impact electric tools) can be calculated, and through the set processing time or the number of times of increase and decrease of electric current, the driving unit 31 is capable of performing a constant torque (pre-lock) operation on the workpiece. After the set operation time or the number of times of increase and decrease of electric current has been reached, it can be determined that the workpiece has been applied with the set torque value, and the driving unit 31 will stop, even if the trigger 42 is continuously pressed, no operating action will be generated. The trigger 42 needs to be released and then pressed again to drive the driving unit 31 again. If switching to a maximum torque output mode, an action of the driving unit 31 will change according to the driving manipulation signal D generated by the trigger 42. Keep pressing the trigger 42 and the driving unit 31 will continue to operate. A magnitude of a torque will change with a depth of the trigger 42 being pressed. The deeper a depth of the trigger 42 being pressed, the higher a relative torque value, and a highest operating torque will be achieved when an ultimate torque value set by the electric tool 20 is reached until the trigger 42 is released. And according to a direction manipulation signal of the reversing member 41, clockwise or counterclockwise rotation is performed.

Please refer to FIGS. 6(A), 6(B) and 7(A). When an operation mode of the driving unit 31 is to be switched, the driving unit 31 is kept in a stationary state, and then the trigger 42 of the manipulation unit 40 is pressed to enable the trigger 42 to be capable of generating a manipulation signal to wake up the control unit 60, and then perform an operation for switching an operation mode for the manipulation unit 40. In this embodiment, when the reversing member 41 is used to switch an operation mode, within the time interval T the reversing member 41 is switched from its original position, such as a clockwise position, to a counterclockwise position, and then switched to a clockwise position to generate changes in signal of switching from the clockwise manipulation signal W1 to the counterclockwise manipulation signal W2, and then back to the clockwise manipulation signal W1 again. After actions are completed, the reversing member 41 remains at an original rotating position. At this time, the processing portion 611 receives a signal of the operation for switching operation mode and determines that the operation for switching operation mode is an operation mode switching request, an operation mode switching procedure will be carried out, and the constant torque (pre-lock) mode will be switched to the maximum torque output mode, or the maximum torque output mode will be switched to the constant torque (pre-lock) mode. In implementation, operation modes of the electric tool 20 can also be designed into three different operation modes, which are a first constant torque (pre-lock) mode, a second constant torque (pre-lock) mode and a maximum torque output. In this way, three different operation modes are switched in a sequence of switching from the first constant torque (pre-lock) mode to the second constant torque (pre-lock) mode, from the second constant torque (pre-lock) mode to the maximum torque output mode, and from the maximum torque output mode to the first constant torque (pre-lock) mode. After the processing portion 611 receives the operation for switching operation mode generated by the manipulation unit 40 within the time interval T, and if it is determined that the operation for switching operation mode is an operation mode switching request, the confirmation signal L will be generated synchronously and transmitted to the confirmation unit 50 through the processing portion 611, so that the light-emitting device 51 of the confirmation unit 50 is immediately turned from an original light-emitting state before a rotation speed is switched to a light-off state. Compared with the original change in which the confirmation unit 50 will continue to emit light for 3-5 seconds and then turn off when the control unit 60 is awakened after the trigger 42 is released, a user can know that an action of switching rotation speed has been completed. If the confirmation unit 50 adopts the driving unit 31 as a display, the confirmation signal L is capable of making the driving unit 31 rotate half a turn or rotate for one second, and display the completion of switching operation mode through the components of the electric tool 20 itself.

Please refer to FIG. 7(A). The user can also switch an operation mode by pressing the trigger 42. Before switching an operation mode, the trigger 42 is pressed once to wake up the control unit 60, within the time interval T the trigger 42 is pressed, then the trigger 42 is released, the trigger 42 is pressed again, and then the trigger 42 is finally released so that the trigger 42 can generate two transient triggerings of the driving manipulation signal D within the time interval T, and the trigger 42 is still kept in an unpressed state. Operation of triggering the driving manipulation signal D by the trigger 42 will generate an operation for switching operation mode for the processing portion 611. After receiving a manipulation signal of the operation for switching operation mode within the time interval T, and if the operation for switching operation mode is determined to be an operation mode switching request, the microprocessor 61 is capable of controlling the switch element 62 to perform an action of switching an operation mode of the driving unit 31. In operation, the manipulation unit 40 is capable triggering only based on the manipulation signals generated by the reversing member 41 or the trigger 42 to perform the operation for switching operation mode, and it is not necessary for all the manipulation units 40 to have the operation for switching operation mode. In addition, please refer to FIG. 7(B), if an operation time of the operation for switching operation mode of the manipulation unit 40 exceeds the time interval T, the processing portion 611 will not determine that the operation for switching operation mode is an operation mode switching request, action of switching operation mode will not be performed, and the confirmation signal L will not be generated for the confirmation unit 50 for display. If the user wants to switch an operation mode, the operation for switching operation mode needs to be performed on the manipulation unit 40 again.

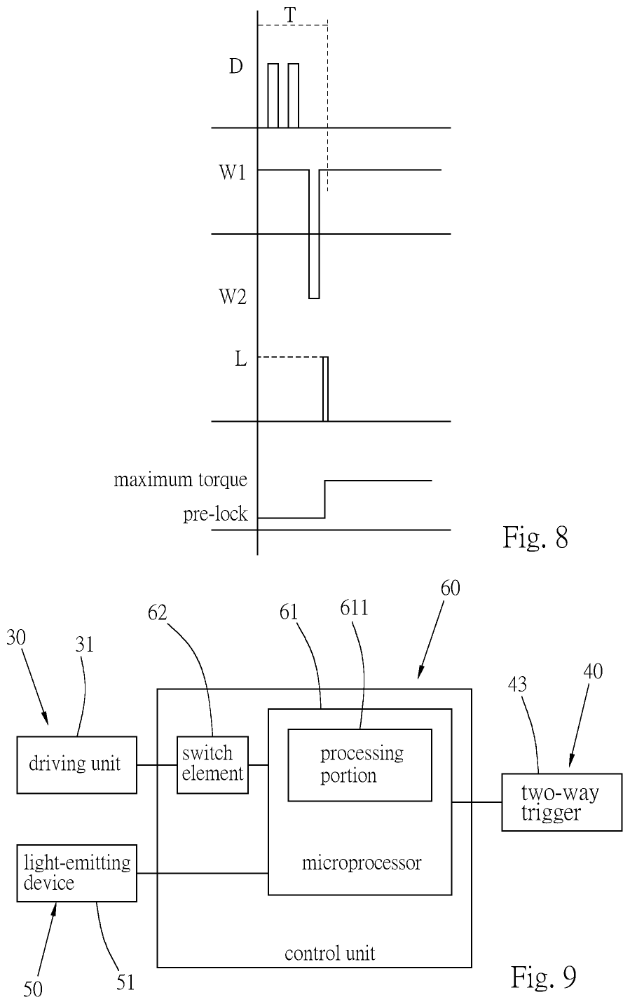

Please refer to FIG. 8. In operation, the operation for switching operation mode can also be performed by using two different manipulation units 40 at the same time, that is, the reversing member 41 is used in conjunction with manipulation signals of the trigger 42. Before switching an operation mode, the trigger 42 is pressed once to wake up the control unit 60, within the time interval T the trigger 42 is pressed, then the trigger 42 is released, the trigger 42 is pressed again, and then the trigger 42 is finally released so that the trigger 42 can generate two transient triggerings of the driving manipulation signal D within the time interval T. Then the reversing member 41 is switched from an original position, such as a clockwise position, to a counterclockwise position, and then switched to a clockwise position to generate changes in signal of switching from the clockwise manipulation signal W1 to the counterclockwise manipulation signal W2, and then back to the clockwise manipulation signal W1 again. After actions are completed, the reversing member 41 remains at an original rotating position. At this time, after the processing portion 611 receives the operation for switching operation mode generated by the manipulation unit 40 within the time interval T, and if it is determined that the operation for switching operation mode is an operation mode switching request, the confirmation signal L will be generated synchronously and transmitted to the confirmation unit 50 through the processing portion 611, so that the light-emitting device 51 of the confirmation unit 50 is immediately turned from an original light-emitting state before an operation mode is switched to a light-off state. Compared with the original change in which the confirmation unit 50 will continue to emit light for 3-5 seconds and then turn off when the control unit 60 is awakened after the trigger 42 is pressed, the user can know that an action of switching rotation speed has been completed. Through combination of the two different manipulation signals of the reversing member 41 and the trigger 42, the user can be prevented from touching accidentally during operation to cause a misoperation.

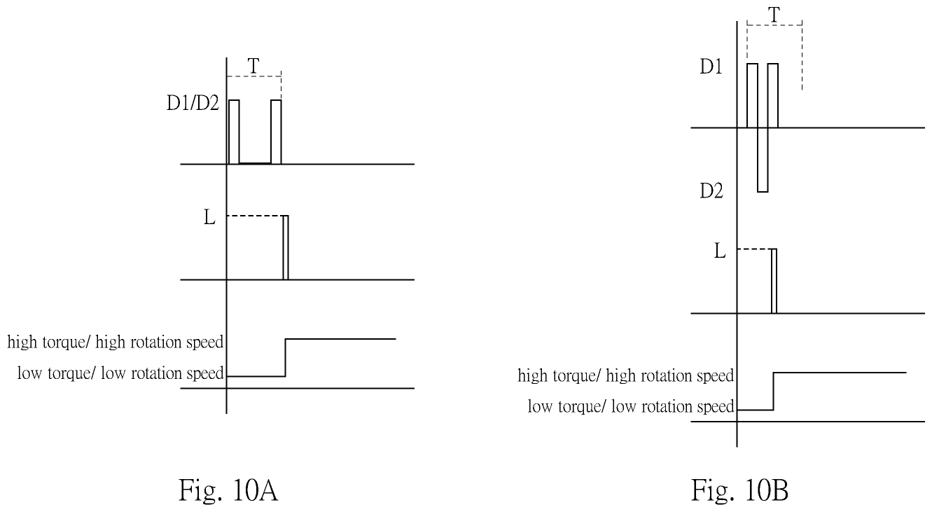

Please refer to FIGS. 9, 10 (A) and 10 (B), which provide a second preferred embodiment of the invention, main structures are the same as that of the previous embodiment, and the same parts use the same reference numerals, which will not be described hereunder again.

The manipulation unit 40 is composed of a two-way trigger 43. The two-way trigger 43 has two different trigger positions. At different trigger positions, a first manipulation signal D1 and a second manipulation signal D2 are generated. When the two-way trigger 43 is pressed to trigger the first manipulation signal D1, the first manipulation signal D1 will be transmitted to the processing portion 611, so that the processing portion 611 is capable of controlling the switch element 62, and the switch element 62 drives the driving unit 31 to rotate in a clockwise direction; and vice versa, when the two-way trigger 43 is pressed to trigger the second manipulation signal D2, the driving unit 31 will rotate in a counterclockwise direction. Rotation and direction of rotation of the driving unit 31 can be controlled simultaneously through the two-way trigger 43. The operation for switching operation mode of the two-way trigger 43 can be as shown in FIG. 10(A), a manipulation signal of pressing a same trigger position causes the two-way trigger 43 to regularly trigger the same manipulation signal (D1/D2) twice within the time interval T to form the operation for switching operation mode. When the processing portion 611 receives the operation for switching operation mode and determines that the operation for switching operation mode is an operation mode switching request, the microprocessor 61 is capable of controlling the switch element 62 to change an operation mode of the driving unit 31. In addition, the operation for switching operation mode of the two-way trigger 43 can be as shown in FIG. 10(B), within the time interval T, a sequential operation (forming a D1-D2-D1 sequence) of triggering the first manipulation signal D1 first, then triggering the second manipulation signal D2, and then triggering the first manipulation signal D1 again is formed as the operation for switching operation mode. In implementation, action mode of the operation for switching operation mode is not limited, as long as the set manipulation signals capable of changing regularly can be completed within the time interval T, a function of switching operation mode can be achieved.

In this embodiment, an operation mode is changed based on a high torque mode or a low torque mode. The operation mode can be switched to operate in the high torque mode or the low torque mode; a torque value of the high torque mode can be 0˜100 N·m, a torque value of the low torque mode can be 0˜50 N·m, and a torque value range can be set according to actual demands. In addition, if an operation mode is changed based on a high rotation speed mode or a low rotation speed mode, the operation mode can be switched to operate in a high rotation speed range or a low rotation speed range. The high rotation speed range of the high rotation speed mode can be 0˜1000 rpm, and the low rotation speed range of the low rotation speed mode is 0˜500 rpm, the rotation speed ranges can be adjusted according to actual demands.

In a change of the above-mentioned operation mode, if it is a high torque mode/low torque mode, a torque value generated by rotation of the driving unit 31 will change with an intensity of pressing the two-way trigger 43, the deeper a depth of the two-way trigger 43 being pressed, the higher a relative torque value, but will not exceed a maximum torque in a torque range; if it is a high rotation speed mode/low rotation speed mode, a rotation speed value generated by rotation of the driving unit 31 will vary with an intensity of pressing the two-way trigger 43, the greater a pressing force applied on the two-way trigger 43, the higher a relative rotation speed, but a maximum rotation speed of a rotation speed range will not be exceeded.

In the operation mode switching device of the invention, the manipulation unit is a component conventionally provided on the electric tool, in addition to being capable of generating the manipulation signal for controlling the driving unit, the operation for switching operation mode can also be generated to control an operation mode of the driving unit. Compared with the conventional operation mode switching requiring additional components and circuit boards, the operation mode switching device of the invention is capable of performing actions for switching operation mode with the original components and structures.

It is to be understood that the above description is only preferred embodiments of the present invention and is not used to limit the present invention, and changes in accordance with the concepts of the present invention may be made without departing from the spirit of the present invention, for example, the equivalent effects produced by various transformations, variations, modifications and applications made to the configurations or arrangements shall still fall within the scope covered by the appended claims of the present invention.

What is claimed is:

1. An operation mode switching device comprising:
a rotatable driving unit;
a manipulation signal;
an operation for switching operation mode; and
a processing portion electrically connected to the driving unit of a main body, the processing portion being capable of receiving the manipulation signal to drive the driving unit, and after an operation for switching operation mode formed by a change in the manipulation signal being received within a time interval, the processing portion determining that the operation for switching operation mode being an operation mode switching request, and the processing portion switching an operation mode of the driving unit.

2. The operation mode switching device as claimed in claim 1, wherein the manipulation signal comprises a driving manipulation signal and/or a direction manipulation signal, and the driving manipulation signal and/or the direction manipulation signal of the manipulation signal can be triggered regularly within the time interval to form the operation for switching operation mode.

3. The operation mode switching device as claimed in claim 1, wherein the manipulation signal comprises a first manipulation signal and a second manipulation signal, both the first manipulation signal and the second manipulation signal are respectively capable of making the driving unit to rotate, and the first manipulation signal and the second manipulation signal drive the driving unit to rotate in different directions; triggering the first manipulation signal and/or the second manipulation signal regularly within the time interval is capable of forming the operation for switching operation mode.

4. The operation mode switching device as claimed in claim 1, wherein after the processing portion determines that there is an operation mode switching request, a confirmation signal is simultaneously generated.

5. The operation mode switching device as claimed in claim 1, wherein the time interval is 1 second or 2 seconds.

6. The operation mode switching device as claimed in claim 1, wherein the manipulation signal is capable of waking up the processing portion.

7. The operation mode switching device as claimed in claim 1, wherein the operation mode comprises at least one constant torque (pre-lock) mode and one maximum torque output mode.

8. The operation mode switching device as claimed in claim 1, wherein the operation mode comprises at least one high torque mode and one low torque mode.

9. The operation mode switching device as claimed in claim 1, wherein the operation mode comprises at least one high rotation speed mode and one low rotation speed mode.

10. An operation mode switching device of an electric tool comprising:
a main body mounted with a rotatable motor;
a manipulation unit capable of triggering to generate a manipulation signal;
the manipulation unit being capable of triggering regularly within a time interval to form an operation for switching operation mode; and
a control unit having a microprocessor and a switch element, the control unit being electrically connected to the motor of the main body and the manipulation unit, the control unit being capable of receiving the manipulation signal of the manipulation unit, the microprocessor controlling the switch element according to the manipulation signal so that the switch element being capable of driving the motor to operate and changing a direction of operation; after the microprocessor receiving the operation for switching operation mode of the manipulation unit, the microprocessor determining that the operation for switching operation mode being an operation mode switching request, the microprocessor being capable of switching an operation mode, and controlling the switch element to change an operation mode of the motor.

11. The operation mode switching device as claimed in claim 10, wherein the manipulation unit is a trigger and/or a reversing member, and the trigger and/or the reversing member of the manipulation unit are/is capable of triggering regularly within the time interval to form the operation for switching operation mode.

12. The operation mode switching device as claimed in claim 11, wherein a manipulation signal of the trigger is capable of driving the motor to rotate; and the operation for switching operation mode of the trigger is formed by pressing the trigger and releasing the trigger at least once.

13. The operation mode switching device as claimed in claim 11, wherein a manipulation signal of the reversing member is capable of controlling a rotation direction of the motor; the operation for switching operation mode formed by the reversing member is to operate the reversing member to perform an action of switching from an original rotation direction position to another rotation direction position and then switching back to the original rotation direction position at least once.

14. The operation mode switching device as claimed in claim 11, wherein a manipulation signal of the trigger is capable of driving the motor to rotate; a manipulation signal of the reversing member is capable of controlling a rotation direction of the motor; and combined regular triggerings of the trigger and the reversing member form the operation for switching operation mode.

15. The operation mode switching device as claimed in claim 10, wherein the manipulation unit is a two-way trigger, the two-way trigger has trigger positions in different directions, different trigger positions are capable of driving the motor to rotate in different directions, and the two-way trigger is capable of triggering regularly to form the operation for switching operation mode.

16. The operation mode switching device as claimed in claim 10, wherein the microprocessor generates a confirmation signal for a confirmation unit after receiving an operation mode switching request.

17. The operation mode switching device as claimed in claim 16, wherein the confirmation unit is a light-emitting device.

18. The operation mode switching device as claimed in claim 10, wherein the operation mode is to control the switch element to change an operating torque of the motor.

19. The operation mode switching device as claimed in claim 10, wherein the operation mode is to control the switch element to change an operating rotation speed range of the motor.
